(19) United States
(12) Patent Application Publication
(10) Pub. No.: US 2007/0198706 A1
(43) Pub. Date: Aug. 23, 2007

(54) METHOD, SYSTEM AND COMPUTER PROGRAM FOR COLLECTING INFORMATION WITH IMPROVED TIME-STAMP ACCURACY

(76) Inventors: Marco Mechelli, Rome (IT); Dario Iorfida, Rome (IT); Andrea Orestano, Roma (IT)

Correspondence Address: IBM CORPORATION;INTELLECTUAL PROPERTY LAW, 11400 BURNET ROAD, AUSTIN, TX, 78758, US

(21) Appl. No.: 11/672,055

(22) Filed: Feb. 7, 2007

(30) Foreign Application Priority Data
Feb. 9, 2006 (EP) 06101467.6

(51) Int. Cl. G06F 15/173

(52) U.S. Cl. 709/224

(57) ABSTRACT

A solution for collecting information from multiple clients on a central server is proposed. Particularly, each client records the start and the stop of any software product, and then uploads the recorded information to the server periodically. For this purpose, the client retrieves the current value Ts(a) of the internal time of the server Ts at its startup; this value Ts(a) is stored onto the client as a time base TB. A monotonic counter is then used to measure a time offset Oc relative to the time base TB. Whenever a record R(i) indicative of the usage of a software product is recorded on the client, it is time-stamped with the time base TB plus the current value of the time offset Oc(i). In this way, the time stamp TR(i) of every usage record R(i) is always synchronized with the internal time of the server Ts (independently of the internal time of the client Tc).

### FIELD OF THE INVENTION

The present invention relates to the information technology field. More specifically, the invention relates to the collection of information in a data processing system.

### BACKGROUND ART

In a data processing system with distributed architecture, information is commonly collected on a central server from multiple local clients; the information items received from the different clients may then be processed on the server by a number of applications. For this purpose, it is often necessary to know when each information item was generated on the corresponding client; this allows correlating the information items correctly for their aggregation.

A typical example is a licensing application for metering the usage of software products in the system. In this case, each client detects when any software product started or stopped running thereon. This information is used by the server to determine the number of instances of each software product running concurrently on the clients at any instant (for example, for charge-back accounting). An example of commercial licensing application is the “IBM Tivoli License Manager (ITLM)” by IBM Corporation.

If the information items generated on the clients would be transmitted to the server immediately, an internal time of the server (defined by its system clock) might be used to correlate the information items. Particularly, the current value of the server internal time at the receiving of each information item is taken as a (common) temporal measure of the instant at which the same information item was generated on the client (disregarding its transmission delay).

However, in most practical situations the information items are collected on the clients and then uploaded to the server in a different phase; this increases the scalability of the solution, and makes it more robust with respect to network outages. In this case, each information item is time-stamped with the current value of an internal time of the corresponding client at its recording. Those time stamps are then used to correlate the corresponding information items on the server.

A drawback of the solution described above is that it cannot ensure the accuracy of the information that is collected on the server. Particularly, any skews among the internal times of the clients generate corresponding misalignments of the time stamps that are measured on the different clients. The same problem is also experienced on a single client when its internal time is updated during operation. All of the above does not allow correlating the information items correctly on the server; in other words, information items generated simultaneously may be associated with different time stamps, or the time elapsed between the generation of two consecutive information items may be wrongly calculated. Considering in particular the licensing application, it is not possible to determine the actual number of instances of each software product running concurrently in the system or the length of the running period of each software product.

A possible solution would be of synchronizing the internal times of the different clients with the one of the server. However, this requires a quite complex infrastructure; moreover, in order to ensure an acceptable degree of accuracy all the clients must communicate with the server continually (with a detrimental impact on the performance of the whole system). In any case, the above-described solution is quite rigid; particularly, it does not allow any adjustment of the internal times of the clients. This restriction may be untenable in many practical applications, wherein it is required to update the internal times of the clients for whatever business need.

### SUMMARY OF THE INVENTION

The present invention provides a solution as set out in the independent claims. Advantageous embodiments of the invention are described in the dependent claims.

In principle, the invention is based on the idea of measuring the time on each client relative to a time base defined according to the internal time of the server.

Particularly, an aspect of the invention proposes a method for collecting information in a data processing system including a central entity (or server) and one or more local entities (or clients). For each local entity the method includes the following steps. At first, there is retrieved an activation value of the internal time of the central entity corresponding to an activation of the local entity. A time base, based on the activation value of the internal time of the central entity, is then stored. The method now involves measuring a time offset relative to the time base; the operation is performed independently of the internal time of the local entity. The method continues by recording a set of (one or more) information items to be uploaded to the central entity (such as indicative of the usage of software products on the local entity). A recording time (or time stamp) is associated to each information item; the recording time is based on the sum between the time base and a recording value of the time offset corresponding to the recording of the information item. At the end, the information items with the associated recording times are uploaded to the central entity.

In an embodiment of the invention, the time offset is measured by means of a monotonic counter.

Typically, the monotonic counter is reset at a startup of the client (and the offset is then obtained by subtracting a current value of the monotonic counter from an initial value thereof).

A way to improve the solution is of estimating the time base (when the server cannot be contacted) according to a current value of the client internal time and a correction value that was stored at the last access to the server.

Preferably, the correction value is calculated when the client is turned-off.

As a further improvement, the uploading is time stamped in a similar way (so as to allow the server to verify the accuracy of the received information by comparing this time stamp with the corresponding value of its internal time).

Advantageously, the difference between the above-mentioned values may be used to correct the information received by the server.

In an embodiment of the invention, the information items recorded during each session of the client preceding the last one (defined between its startup and turnoff) are invalidated if the corresponding time base was estimated.

For example, the proposed solution is used in a software licensing application.

Another aspect of the invention proposes a computer program for performing the method.

A further aspect of the invention proposes a corresponding system.

### REFERENCE TO THE DRAWINGS

The invention itself, as well as further features and the advantages thereof, will be best understood with reference to the following detailed description, given purely by way of a non-restrictive indication, to be read in conjunction with the accompanying drawings, in which:

FIG. 1a is a schematic block diagram of a data processing system in which the solution according to an embodiment of the invention is applicable;

FIG. 1b shows the functional blocks of an exemplary computer of the system;

FIGS. 2a-2c are time diagrams illustrating the solution according to different embodiments of the invention;

FIG. 3 depicts the main software components that can be used to practice the solution according to an embodiment of the invention; and

FIGS. 4a-4c show a diagram describing the flow of activities relating to an implementation of the solution according to an embodiment of the invention.

### DETAILED DESCRIPTION

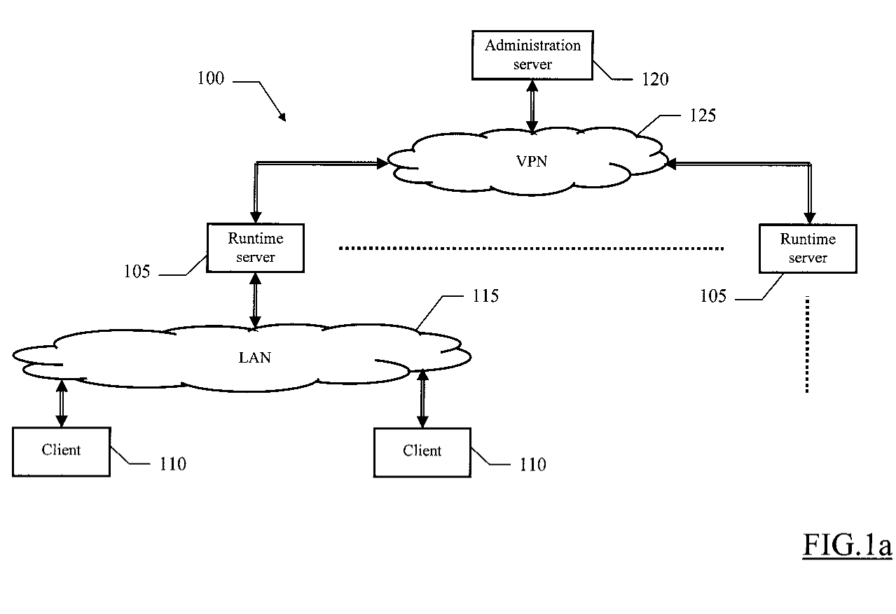

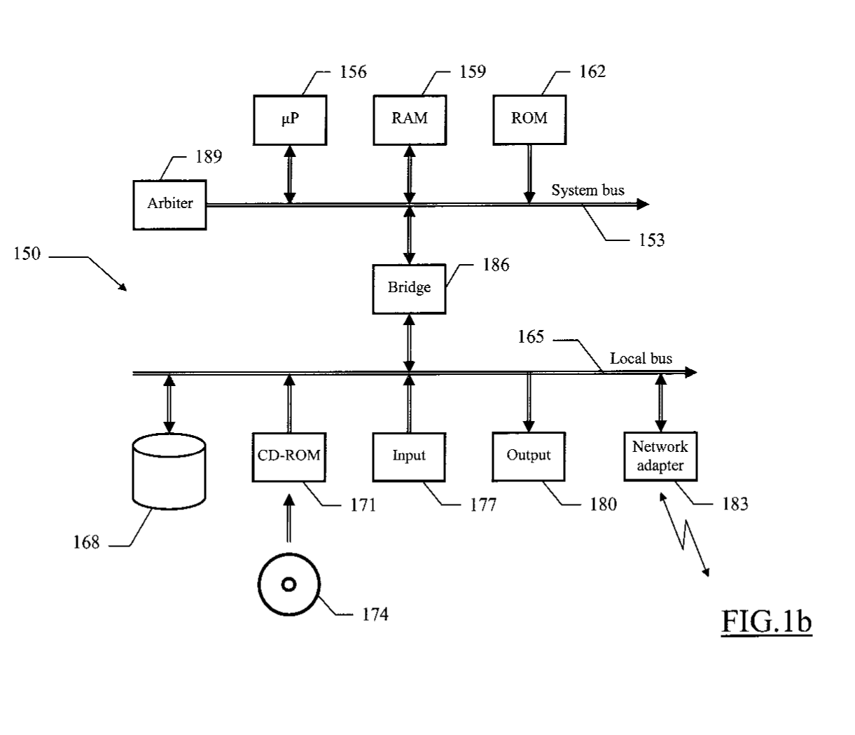

With reference in particular to FIG. 1a, a data processing system 100 with distributed architecture is depicted. The system 100 implements a license management infrastructure (for example, based on the above-mentioned ITLM), which allows metering the usage of selected software products (such as application programs). The system 100 includes one or more independent organizations (only one shown in the figure), which are completely separate and distinct from each other; within the organization, one or more divisions are defined.

Each division is formed by a runtime server 105, which collects information about the usage of assigned software products on a set of corresponding clients (or nodes) 110. For this purpose, each client 110 detects the start and the stop of any software product; corresponding usage records (each one indicating the software product and when it started or stopped) are stored on the client 110. In a next phase, all the stored usage records are uploaded from the client 110 to the runtime server 105 through a network 115 (for example, a LAN).

The different runtime servers 105 report to a single administration server 120, which implements a central control point for inventory, procurement, and accounting information of the whole organization; the runtime servers 105 and the administration server 120 are connected to a different network 125 (for example, a Virtual Private Network or VPN based on the Internet).

Considering now FIG. 1b, a generic computer of the above-described system (runtime server, client, or administration server) is denoted with 150. The computer 150 is formed by several units that are connected in parallel to a system bus 153 (with a structure that is suitably scaled according to the actual function of the computer 150 in the system). In detail, one or more microprocessors (μP) 156 control operation of the computer 150; a RAM 159 is directly used as a working memory by the microprocessors 156, and a ROM 162 stores basic code for a bootstrap of the computer 150. Several peripheral units are clustered around a local bus 165 (by means of respective interfaces). Particularly, a mass storage consists of one or more hard-disks 168 and a drive 171 for reading CD-ROMs 174. Moreover, the computer 150 includes input units 177 (for example, a keyboard and a mouse), and output units 180 (for example, a monitor and a printer). A network adapter 183 is used to plug the computer 150 into the system. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

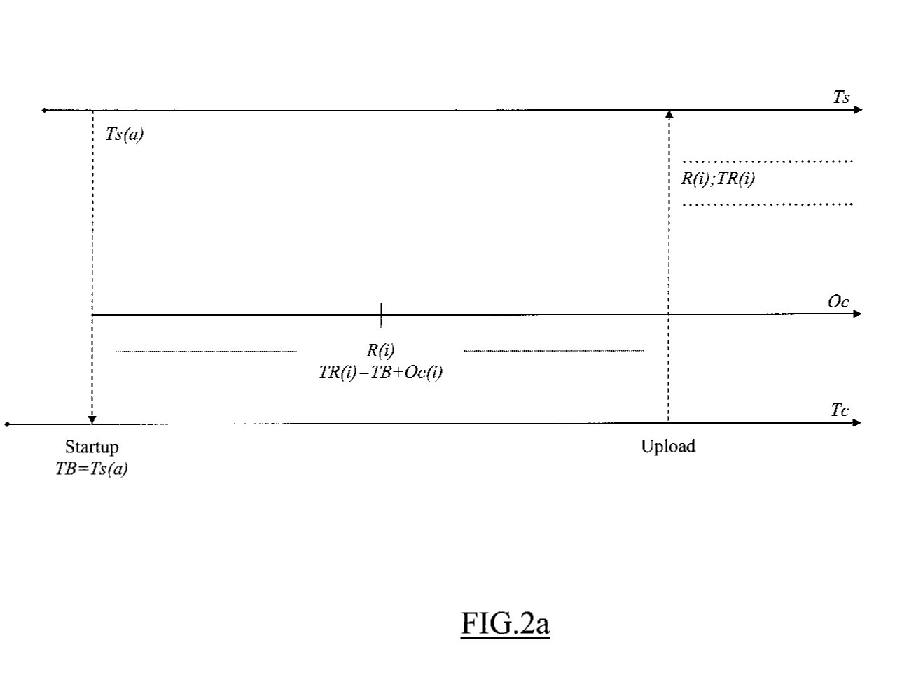

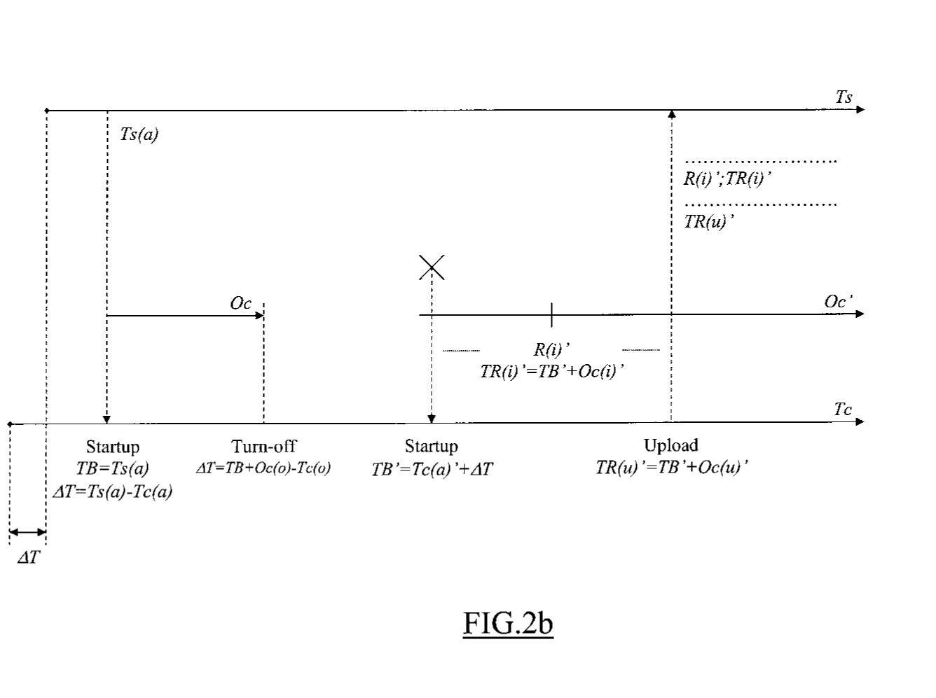

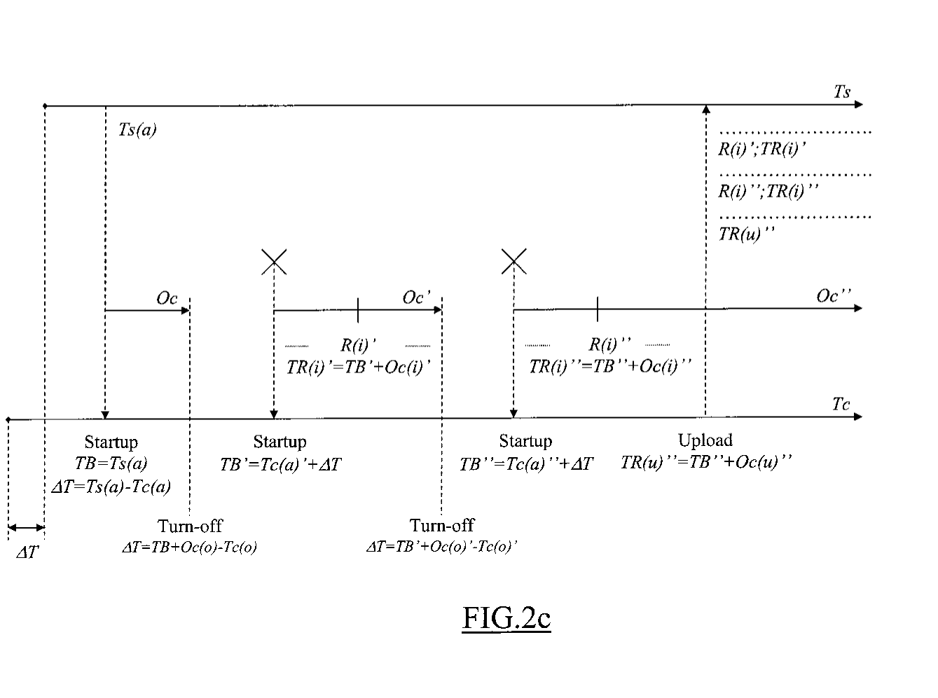

Moving to FIG. 2a, the system clocks of a generic client and of the associated runtime server define corresponding internal times Ts and Tc, respectively (used to indicate the hour and the day). When the client starts-up, it retrieves the current value of the server internal time Ts, denoted with Ts(a). This activation value Ts(a) is stored onto the client as a time base TB=Ts(a). A time offset Oc then measures the time relative to the time base TB. For this purpose, there is exploited a counter (running at the same rate as the system clock of the client), which is independent of the client internal time Tc. Preferably, the counter is read-only; this ensures that the counter is monotonic, i.e., it consistently increases (and never decreases) with time. Examples of monotonic counters well suited for this purpose are a TimeBase Register (TBR) of the microprocessor (which is reset at the power-on of the client), or a System Uptime provided by an operating system of the client, such as Linux (which is reset at the bootstrap thereof).

Whenever a new usage record is stored on the client, it is associated with a recording time stamp defined by the time base TB plus the current value of the time offset Oc. More specifically, denoting with Oc(i) the value of the time offset Oc at the storing of the i-th usage record R(i), the corresponding recording time stamp will be TR(i)=TB+Oc(i). Later on, all the usage records R(i) with their recording time stamps TR(i) are uploaded to the runtime server.

In this way, the recording time stamps TR(i) received by the runtime server are always synchronized with its internal time Ts. Indeed, the time base TB=Ts(a) is correct by definition (disregarding the delay due to the transmission of the activation value Ts(a) to the client); moreover, the time offset Oc and the server internal time Ts measure the time after the definition of the time base TB at the same rate (assuming that any skew between the system clocks of the client and of the runtime server is negligible). Therefore, any recording time stamp TR(i)=TB+Oc(i) is substantially equal to the value of the server internal time Ts at the same instant (when the corresponding usage record R(i) was stored on the client).

It is emphasized that this result is completely independent of the client internal time Tc. Therefore, any difference between the internal times Tc and Ts does not affect the correctness of the information that is collected on the runtime server. Particularly, the proposed solution is insensitive to any skew of the client internal time Tc or to its updates.

All of the above ensures a high accuracy of the information collected on the runtime server. This makes it possible to correlate the usage records R(i) correctly on the runtime server; particularly, the above-described technique preserves the simultaneously of the events relating to the generation of the usage records R(i) on difference clients and the actual value of the time elapsed between the generation of each pair of consecutive usage records R(i).

The devised solution is very flexible, since no restriction is set to the client internal time Tc. Particularly, it is now possible to adjust the client internal time Tc at will (for example, to meet specific business needs), without any impact on the accuracy of the information collected on the runtime server.

The solution according to another embodiment of the invention is illustrated in FIG. 2b. As in the preceding case, when the client starts-up it retrieves the activation value Ts(a) from the runtime server and sets the time base TB=Ts(a) accordingly. At the same time, the client also calculates a difference between the time base TB and the corresponding value of the client internal time Tc, denoted with Tc(a). The result of the operation is stored onto the client as a correction value ΔT=Ts(a)−Tc(a), which represents the current difference between the server internal time Ts and the client internal time Tc.

Later on, the client is turned-off. In this phase, the correction value ΔT is recalculated according to the current difference between the server internal time Ts and the client internal time Tc. Particularly, the value of the internal time of the server Ts at the turnoff of the client is equal to the time base TB plus the corresponding value of the time offset Oc, denoted with Oc(o) (assuming that any skew between the system clocks of the client and of the runtime server is negligible); therefore, denoting with Tc(o) the value of the client internal time Tc at the same instant, the correction value will be ΔT=TB+Oc(o)−Tc(o). This increases the accuracy of the correction value ΔT, since it allows taking into account any change of the client internal time Tc that has occurred meanwhile.

When the client starts-up again, it is now unable to contact the runtime server to obtain the current value of its internal time Ts. In this case, a new time base TB′ (all the values relating to this new session of the client, defined between its startup and turnoff, will be discriminated hereinafter by adding an apostrophe) is estimated equal to the current value of the client internal time Tc, denoted with Tc(a)′, plus the correction value ΔT, i.e., TB′=Tc(a)′+ΔT. The time offset Oc′ relative to the time base TB′ is then measured as indicated above, and it is used to define the recording time stamps TR(i)′ for the new usage records R(i)′ that are stored on the client afterwards, i.e., TR(i)′=TB′+Oc(i)′.

When the collected information must be uploaded to the runtime server, the client likewise calculates a corresponding time stamp TR(u)′ by adding the current value of the time offset Oc′, denoted with Oc(u)′, to the time base TB′, i.e., TR(u)′=TB′+Oc(u)′. The usage records R(i)′ with their recording time stamps TR(i)′ and the uploading time stamp TR(u)′ are then transmitted to the runtime server.

If the client internal time Tc was not changed between the two starts-up of the client, the correction value ΔT still represents the difference between the server internal time Ts and the client internal time Tc (assuming that any skew between the system clocks of the client and of the runtime server is negligible). Therefore, the time base TB′ is correct (i.e., it is substantially equal to the value of the server internal time Ts at the same instant, disregarding the delay due to the transmission of the activation value Ts(a) to the client); as a result, the recording time stamps TR(i)′ received by the runtime server are synchronized with its internal time Ts for the same reasons set out above.

Conversely, any change of the client internal time Tc introduces an unknown error in the time base TB′, which reflects in all the recording time stamps TR(i)′ and in the uploading time stamp TR(u)′ that are received by the runtime server. However, it is possible to determine this error by simply comparing the uploading time stamp TR(u)′ with the corresponding value of the server internal time Ts. The value so obtained can then be used to restore the correctness of the recording time stamps TR(i)′. More specifically, the time base TB′ can be expressed as TB′=TB′c+E′, wherein TB′c is its correct value (corresponding to the actual value of the server internal time Ts at the same instant) and E′ is the error introduced by the change in the client internal time Tc; it follows that:

TR(i)′=TB′+Oc(i)′=TB′c+E′+Oc(i)′, and

TR(u)′=TB′+Oc(u)′=TB′c+E′+Oc(u)′.

The value of the server internal time Ts corresponding to the uploading time stamp TR(u)′, denoted with Ts(u)′, is substantially equal to the time elapsed (as measured by the value Oc(u)′ of the time offset Oc′) since the correct value of the time base TB′c, i.e., Ts(u)′=TB′c+Oc(u)′; therefore, the difference Du′=TR(u)′−Ts(u)′ provides the error E′:

Du′=TR(u)′−Ts(u)′=TB′c+E′+Oc(u)′−[TB′+Oc(u)′]=E′.

### The values obtained by subtracting the error E′ from the recording time stamps TR(i)′:

TR(i)′−E′=TB′c+E′+Oc(i)′−E′=TB′c+Oc(i)′

are then again correctly synchronized with the server internal time Ts.

However, it should be noted that the received information can be corrected only for a last session of the client. For example, as shown in FIG. 2c, the client is turned off (after the startup at which the time base TB′ was simply estimated) without uploading the collected information to the runtime server. Later on, the client is started-up again but it is still unable to contact the runtime server, so that a new time base TB″ (all the values relating to this new session of the client will be discriminated hereinafter by adding two apostrophes) is estimated equal to the current value of the client internal time Tc(a)″ plus the correction value ΔT, i.e., TB″=Tc(a)″+ΔT. The time offset Oc″ relative to the time base TB″ is then used as indicated above to define the recording time stamps TR(i)″ for the new usage records R(i)″ that are stored on the client afterwards, i.e., TR(i)″=TB″+Oc(i)″. The collected information is now uploaded to the runtime server, together with the corresponding uploading time stamp TR(u)″=TB″+Oc(u)″.

Therefore, the uploading time stamps TR(i)″ collected during the last session of the client can be corrected as indicated above, because the time elapsed since the client was started-up is measured by the time offset Oc″. Conversely, it is impossible to know the time elapsed since the previous startup of the client; indeed, the monotonic counter is reset at every startup of the client, and then no information is available about the period on which it was off. Therefore, it is not possible to make any assumption about the possible error in the corresponding (estimated) time base TB′, and then in the recording time stamps TR(i)′.

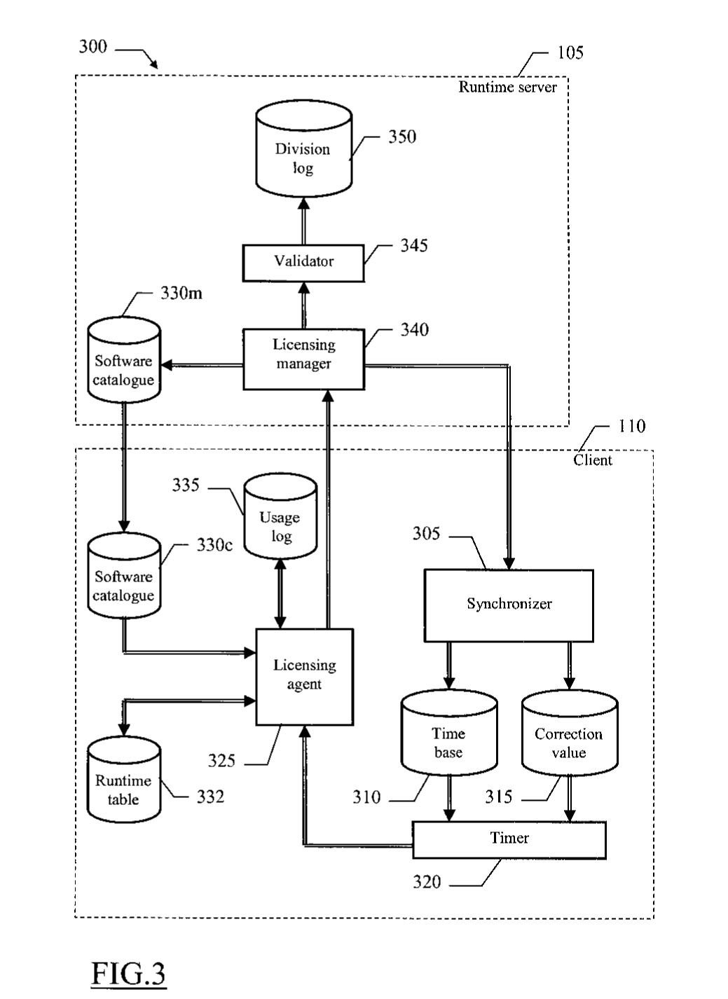

Moving to FIG. 3, the main software components that run on the above-described system are denoted as a whole with the reference 300. The information (programs and data) is typically stored on the hard-disk and loaded (at least partially) into the working memory of each computer when the programs are running. The programs are initially installed onto the hard disk, for example, from CD-ROM.

Considering in particular a generic client 110, a synchronizer 305 contacts the associated runtime server 105 to retrieve the current (activation) value Ts(a) of its internal time Ts. The synchronizer 305 determines the time base TB of each new session, and stores it into a register 310; moreover, the synchronizer 305 also calculates and stores the last available correction value ΔT into another register 315. The registers 310 and 315 are accessed by a timer 320, which calculates the (recording and uploading) time stamps TR(i),TR(u) for a licensing agent 325.

The licensing agent 325 detects the software products that are running on the client 110. For this purpose, the licensing agent 325 accesses a local copy of a software catalogue 330c that is downloaded from the runtime server 105 (for example, periodically or at any change thereof). The software catalogue 330c specifies all the known software products to be metered in the organization. Each software product is identified by a signature defined by one or more executable modules, which indicate the use of the software product when running; typically, each executable module is specified in the software catalogue 330c by means of multiple attributes (such as its name, size and checksum).

More in detail, the licensing agent 325 periodically detects all the software products that are currently running on the client 110 (including the available information about any unknown software product that has not been recognized); this information is compared with the content of a runtime table 332, which provides a snapshot of the software products in use on the client 110; in this way, it is possible to determine the software products that have been started or stopped since the last iteration of the operation (with the runtime table 332 that is updated accordingly).

For each software product that was started or stopped, a corresponding usage record R(i) is generated (by specifying the software product and the occurred event); all the usage records R(i) are then associated with a common (recording) time stamp TR(i) provided by the timer 320. The information so obtained is added to a usage log 335.

Periodically, the licensing agent 325 extracts all the usage records R(i) with the corresponding recording time stamps TR(i) from the usage log 335; at the same time, the licensing agent 325 obtains the current (uploading) time stamp TR(u) from the timer 320. This usage information is then transmitted to the runtime server 105 (together with an identifier of the client 110).

Considering now the runtime server 105, a licensing manager 340 interfaces with the licensing agent 325 (to receive the usage information) and with the synchronizer 305 (to transmit the current value of its internal time Ts) of every client 110 in the division. The licensing manager 340 passes the usage information of each client 110 to a validator 345. The validator 345 verifies the accuracy of the received information. Particularly, the validator 345 determines whether the recording time stamps TR(i) are synchronized with the server internal time Ts; the usage records R(i) with misaligned recording time stamps TR(i) are corrected if possible or they are discarded otherwise.

The usage information so validated is saved into a (global) division log 350, and transmitted to the administration server (not shown in the figure). Moreover, the licensing manager 340 also downloads a main copy of the software catalogue (denoted with 330m) from the same administration server (for example, periodically or at any change thereof).

Typically, the administration server aggregates the received information into a usage report. The usage report lists the software products that ran on the clients 110 in a predetermined period (such as the last day); for each software product, the usage report specifies the length of any running period on a different number of clients 110. This information may be used to charge a prescribed licensing fee for any usage peak of the known software products (according to predefined rates).

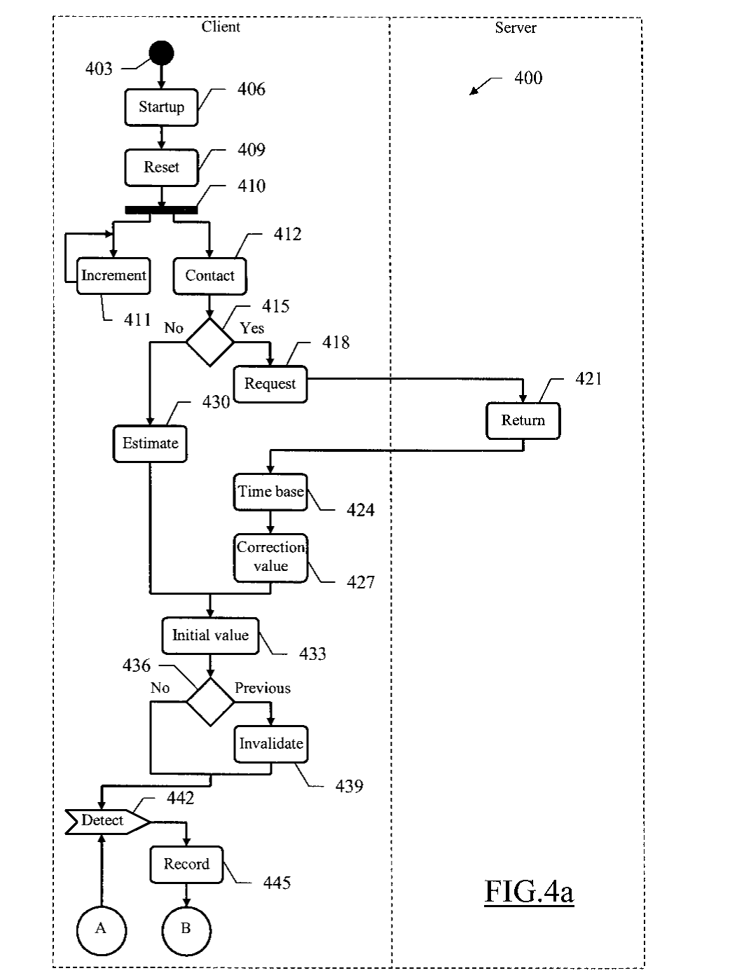

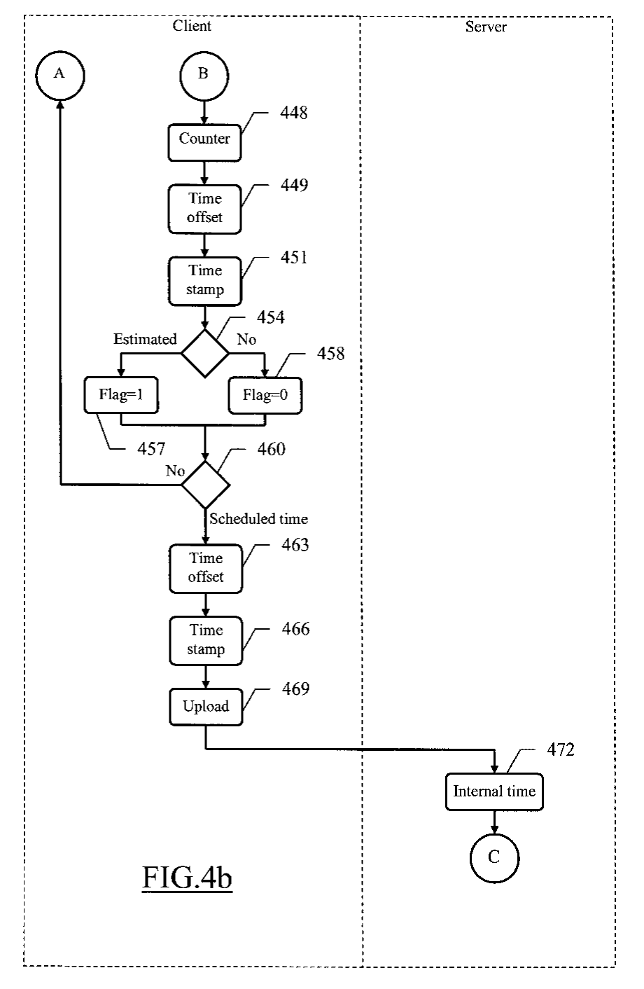

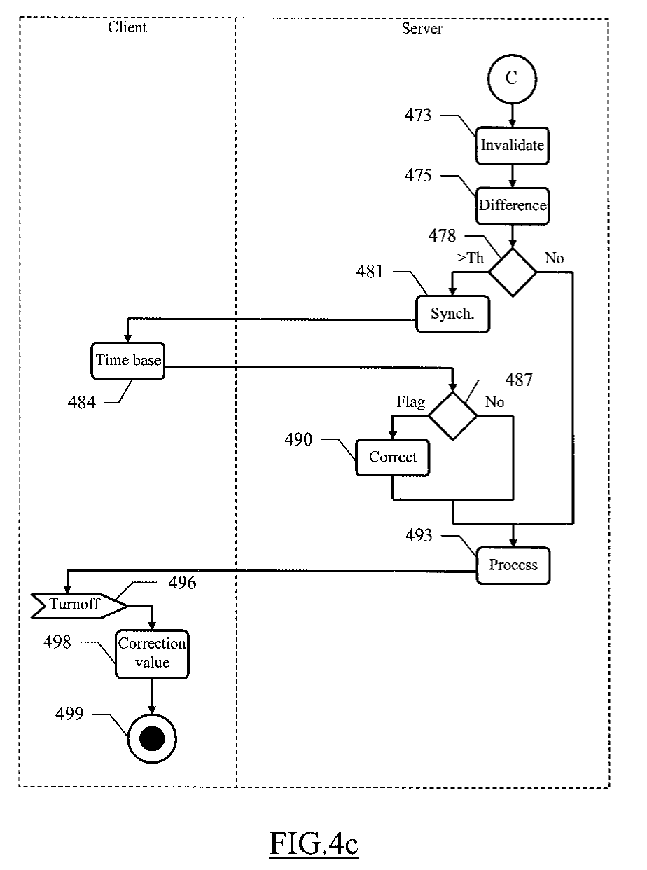

With reference now to FIGS. 4a-4c, the logic flow of an exemplary process that can be implemented in the above-described system (to meter the usage of the desired software products) is represented with a method 400. The method 400 begins at the black start circle 403 in the swim-lane of a generic client. The process descends into block 406 as soon as the client starts up. Proceeding to block 409, the monotonic counter that will be used to define the time offset Oc is reset (such as the TimeBase Register at the power-on or the System Uptime at the bootstrap).

The method 400 then forks at the synchronization bar 410 into two branches that are executed concurrently. Considering in particular block 411, the monotonic counter is incremented continuously (at the same rate as the system clock of the client) so as to measure the time elapsed since its reset.

At the same time, the client tries to contact the associated runtime server at block 412. If the attempt succeeds (decision block 415), the client at block 418 submits a request for the current value of the server internal time Ts. Continuing to block 421, the runtime server returns the required information to the client. In response thereto, the client at block 424 stores this activation value Ts(a) of the server internal time Ts as the time base TB of the new session; at the same time, a synchronization flag indicating the result of the operation is asserted. The process then passes to block 427, wherein the client calculates and stores the correction value ΔT (given by the difference between the time base TB and the corresponding value Tc(a) of the client internal time Tc).

Referring back to block 415, if the client is unable to contact the runtime server, the flow of activity descends into block 430. In this phase, the client sets the (estimated) time base TB to the current value Tc(a) of the client internal time Tc plus the correction value ΔT; at the same time, the synchronization flag is deasserted (to indicate that the attempt of contacting the runtime server failed).

In both cases, the method 400 then joints at block 433 (either from block 427 or from block 430); particularly, a current value of the monotonic counter, denoted with C(O), is saved as an initial value for calculating the time offset Oc(as explained later on). A test is now made at block 436 to determine whether any usage record R(i) was recorded during previous sessions of the clients (wherein the corresponding time bases TB were estimated because of the impossibility of contacting the runtime server); for this purpose, the client checks an estimation flag associated with each usage record R(i), which is asserted to indicate the above-mentioned situation (as described in the following). If so, every usage record R(i) which estimation flag is asserted is invalidated at block 439 (for example, by asserting a corresponding invalidation flag); the method 400 then descends into block 442. The same point is also reached from block 436 directly when the estimation flags of all the usage records R(i) are deasserted.

With reference now to block 422, whenever the licensing agent detects the start or the stop of any software product on the client, a corresponding new usage record R(i) is generated at block 445. Proceeding to block 448, the client retrieves the current value of the monotonic counter, denoted with C(i). The process then passes to block 449, wherein the corresponding value of the time offset Oc(i) is calculated as the difference between the current value C(i) and the initial value C(0) of the monotonic counter, i.e., Oc(i)=C(i)−C(0). The recording time stamp TR(i) of the usage record R(i) can now be obtained at block 451 by adding this value of the time offset Oc(i) to the time base TB, i.e., TR(i)=TB+Oc(i). The licensing agent verifies at block 454 whether the time base TB of the session was estimated (according to the value of the synchronization flag). If so, the estimation flag associated with the usage record R(i) is asserted at block 457; conversely, the same estimation flag is deasserted at block 458.

In both cases, the licensing agent verifies at block 460 whether the time scheduled for the uploading of the recorded usage records R(i) has been reached (for example, at the end of every day). If not, the flow of activity returns to block 442 to reiterate the same operations described above.

As soon as the scheduled time expires, the client at block 463 likewise calculates the current value of the time offset Oc(u) as the difference between the current value, denoted with C(u), and the initial value C(0) of the monotonic counter, i.e., Oc(u)=C(u)−C(0). The uploading time stamp TR(u) is then obtained at block 466 by adding this value of the time offset Oc(u) to the time base TB, i.e., TR(u)=TB+Oc(u). Proceeding to block 469, all the usage records R(i) with their recording time stamps TR(i) and the uploading time stamp TR(u) are transmitted to the runtime server.

Moving now to block 472 in the swim-lane of the runtime server, the validator at first saves the current value Ts(u) of the server internal time Ts. Continuing to block 473, all the usage records R(i) with the invalidation flags asserted are discarded (since the accuracy of their recording time stamps TR(i) cannot be guaranteed). It should be noted that generally this is not critical in many applications; indeed, the resulting loss of information is often preferable than its inaccuracy (since it only involves an undercharging for the usage of the software products but ensures that no overcharging is performed).

Continuing to block 475, the difference Du between the uploading time stamp TR(u) and the corresponding value of the server internal time Ts(u) (saved at block 472) is calculated. A test is now made at block 478 to determine whether this uploading difference Du exceeds a predefined threshold Th (accounting for the transmission delays, for example, 1-10 s). If so, the client is re-synchronized with the runtime server; for this purpose, at block 481 the uploading difference Du is transmitted to the client. In response thereto, the client at block 484 updates its time base TB accordingly, i.e., TB=TB−Du. Returning to the swim-lane of the runtime server, for each (remaining) usage record R(i) the validator verifies at block 487 whether the corresponding estimation flag is asserted. If so, the recording time stamp TR(i) of the usage record R(i) is corrected by subtracting the uploading difference Du, i.e., TR(i)=TR(i)−Du. The flow of activity then continues to block 493. The same point is also reached directly from block 487 (when the estimation flags of all the usage records R(i) are deasserted) or from block 478 (when the uploading difference Du is lower than the threshold Th).

With reference now to block 493, the information so validated is saved (into the division log) for its next processing. For example, as soon a predefined time-out expires (for example, at the end of every week), the licensing manager uploads the information available in the division log to the administration server. In response thereto, the administration server aggregates the received information into a new usage report, which is then analyzed (for example, to charge the applicable licensing fees).

Returning to the swim-lane of the client, when it is turned-off (block 496) the flow of activity descends into block 498. In this phase, the correction value ΔT is recalculated according to the current difference between the server internal time Ts and the client internal time Tc, i.e., ΔT=TB+OC(o)−Tc(o) The method then ends at the concentric white/black stop circles 499.

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

Particularly, similar considerations apply if the system has a different architecture or includes equivalent units; for example, the clients (down to a single one) may be associated with a single server (which receives and processes the usage information at the same time). Moreover, each computer may have another structure or may include similar elements (such as cache memories temporarily storing the programs or parts thereof to reduce the accesses to the mass memory during execution); in any case, it is possible to replace the computer with any code execution entity (such as a PDA, a mobile phone, and the like).

Alternatively, the time base TB is set at a different instant (such as when the licensing application is started, or more generally at a generic hardware or software activation of whatever functionality of the client); moreover, nothing prevents defining the time base TB in a different way, for example, taking into account an estimated transmission delay of the activation value Ts(a).

Although in the preceding description reference has been made to specific monotonic counters, this is not to be intended in a limitative manner; indeed, the invention lends itself to be implemented by using different hardware or software counters of the client (even non-read-only).

Without departing from the principles of the invention, it is also possible to exploit equivalent structures only dedicated to this purpose (such as an internal register of the licensing agent); in this case, the counter may be reset at the activation of the client so as to provide the time offset Oc directly (without the need of storing its initial value).

Similar considerations apply if the correction value ΔT is calculated in a different way, such as taking into account the estimated transmission delay of the activation value Ts(a), and if the time base TB is estimated with equivalent formulas. In any case, a basic implementation of the invention only supporting the set of the time base TB to the activation value Ts(a), without the possibility of estimating its value, is not excluded.

Alternatively, the correction value ΔT may be stored at the turnoff of the client only, or it may be recalculated whenever its internal time Tc is changed; conversely, it is possible to avoid recalculating the correction value ΔT (always using its value as defined at the startup of the client).

Likewise, the accuracy of the information received on the server may be determined with different criteria (for example, defining the threshold Th dynamically according to a mean response time of the network). It should also be noted that the same process is applicable to the recording time stamps TR(i) of every usage records R(i); for example, this allows detecting any skew between the internal times Tc,Ts of the client and of the runtime server when the corresponding time base TB was defined according to the activation value Ts(a).

Alternatively, the recording time stamps TR(i) are corrected in a different way (for example, by subtracting the uploading difference Du minus the threshold Th). However, the feature of correcting the recording time stamps TR(i) is not strictly necessary and it may be omitted in a basic implementation of the invention; in this case, for example, all the usage records R(i) are discarded when the difference between the respective uploading time stamp TR(u) and the corresponding value Ts(u) of the server internal time Ts exceeds the threshold Th.

Moreover, a simplified embodiment supporting a single session of the client is not excluded. In any case, the invalidated information may be preserved (for example, by simply providing a warning). Alternatively, the invalidated information may be discarded directly on the clients (without transmitting it to the runtime server). The choice of where to perform the operation is typically driven by optimization considerations based on the probability of recording invalid information; for example, it is preferable to discard the invalidated information on the clients in a highly reliable system or on the runtime server otherwise.

It should be readily apparent that the implementation of the present invention is not limited to any specific licensing application and/or technique for identifying the software products that are running on the clients; for example, it is possible to detect the invocation of any new software product (consisting of whatever digitally encoded item, such as an electronic book) by intercepting the launching of the corresponding process (for example, using a kernel hooking technique). Moreover, the available information may be simply used to verify compliance with applicable conditions of use, or more generally for whatever management purpose. In any case, the solution according to the present invention lends itself to be used in different environments (such as for monitoring applications).

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (having similar or additional steps, even in a different order). In any case, the program may take any form suitable to be used by or in connection with any data processing system, such as external or resident software, firmware, or microcode (either in object code or in source code). Moreover, the program may be provided on any computer-usable medium; the medium can be any element suitable to contain, store, communicate, propagate, or transfer the program. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type.

In any case, the solution according to the present invention lends itself to be carried out with a hardware structure (for example, integrated in a chip of semiconductor material), or with a combination of software and hardware.

1. A method for collecting information in a data processing system including a central entity and at least one local entity, for each local entity the method including the steps of:
retrieving an activation value of the internal time of the central entity corresponding to an activation of the local entity,
storing a time base based on the activation value of the internal time of the central entity,
measuring a time offset relative to the time base independently of the internal time of the local entity,
recording a set of information items to be uploaded to the central entity,
associating a recording time to each information item based on the sum between the time base and a recording value of the time offset corresponding to the recording of the information item, and
uploading the information items with the associated recording times to the central entity.

2. The method according to claim 1, wherein the step of measuring the time offset includes:
incrementing a monotonic counter.

3. The method according to claim 2, wherein the counter is reset at a startup of the local entity, the step of measuring the time offset further including:
recording an initial value of the counter corresponding to the storing of the time base,
and the step of associating the recording time to each information item including: detecting a recording value of the counter corresponding to the recording of the information item, and
calculating the recording value of the time offset according to the difference between the recording value of the counter and the initial value of the counter.

4. The method according to claim 1, further including the steps of:
storing a correction value based on the difference between the time base and a corresponding value of the internal time of the local entity, and
estimating the time base for a further activation of the local entity in response to a failure of the retrieving of the activation value of the internal time of the central entity, the time base being estimated according to a corresponding value of the internal time of the local entity and the correction value.

5. The method according to claim 4, wherein the step of storing the correction value includes:
calculating the correction value in response to a turnoff of the local entity, the correction value being based on the time base plus a value of the time offset corresponding to the turnoff minus a value of the internal time of the local entity corresponding to the turnoff.

6. The method according to claim 4, further including the steps of:
transmitting an uploading time to the central entity, the uploading time being based on the sum between the estimated time base and a value of the time offset corresponding to the uploading of the information items, and
determining an accuracy of the recording times according to a comparison between the uploading time and a value of the internal time of the central entity corresponding to the uploading the information items.

7. The method according to claim 6, further including the steps of:
correcting the recording times according to the difference between the uploading time and the value of the internal time of the central entity corresponding to the uploading of the information items.

8. The method according to claim 4, wherein a sequence of further activations of the local entity with the failure of the retrieving of the activation value of the internal time of the central entity is performed before the uploading of the information items, the method further including the step of:
invalidating the recording times based on each estimated time base non-corresponding to a last further activation in the sequence.

9. The method according to claim 1, wherein the step of recording the set of information items includes:
detecting the start or the stop of each one of a set of software products on the local entity for use by a software licensing application.

10. (canceled)

11. (canceled)

12. A computer program product in a computer-usable medium, the computer program when executed on a data processing system including a central entity and at least one local entity causing the system to perform a method for collecting information in the system, the method including the steps of:
retrieving an activation of the internal time of the central entity corresponding to an activation of the local entity,
storing a time base based on the activation value of the internal time of the central entity,
measuring a time offset relative to the time base independently of the internal time of the local entity,
recording a set of information items to be uploaded to the central entity,
associating a recording time to each information item based on the sum between the time base and a recording value of the time offset corresponding to the recording of the information item,
uploading the information items with the associated recording times to the central entity.

13. A data processing system including a central server and at least one local client, for each local client the system including:
a synchronizer for retrieving an activation value of the internal time of the central server corresponding to an activation of the local client and for storing a time base based on the activation value of the internal time of the central server,
a timer for measuring a time offset relative to the time base independently of the internal time of the local client, and
an agent for recording a set of information items to be uploaded to the central server, for associating a recording time to each information item based on the sum between the time base and a recording value of the time offset corresponding to the recording of the information item, and for uploading the information items with the associated recording times to the central server.
